(19) United States
(12) Patent Application Publication
(10) Pub. No.: US 2011/0248150 A1
(43) Pub. Date: Oct. 13, 2011

(54) DEVICE FOR QUANTIFYING AND LOCATING A LIGHT SIGNAL MODULATED AT A PREDETERMINED FREQUENCY

(75) Inventors: Claude Bureau, Cendras (FR); Philippe Plantier, Nimes (FR)

(73) Assignee: H21 TECHNOLOGIES, Nimes (FR)

(21) Appl. No.: 13/139,820

(22) PCT Filed: Dec. 11, 2009
(86) PCT No.: PCT/FR09/52498

§ 371 Date: Jun. 15, 2011

(30) Foreign Application Priority Data
Dec. 23, 2008 (FR) 0859048

(51) Int. Cl. G01J 1/44

(52) U.S. Cl. 250/214.1

(57) ABSTRACT

The invention concerns a device for quantifying and locating a light signal modulated at a predetermined frequency. According to the invention, it comprises a digital control unit (100), a plurality of photodiodes (D1,D2,D3,D4) arranged along two parallel, adjacent receiver lines (L+,L−) of similar dimensional and electric characteristics extending from an amplifier device (300) connected to a demodulator (400) and forming a differential pair at the input of the amplifier device (300). The controls over the diodes (D1,D2,D3,D4) are such that they are successively connected to the two receiver lines (L+,L−). The amplifier device (300), which outputs at each instant a signal quantifying the light received by the photodiode(s) (D1,D2,D3,D4) connected to the two receiver lines (L+,L−) at this instant, further comprises a transimpedance amplifier stage (310) whose inputs are each connected to one of the receiver lines (L+,L−) of the differential pair, and a frequency filtering stage (320) capable of allowing the passing of signals at the predetermined frequency and of filtering at least the continuous or low frequency signals.

### BACKGROUND OF THE INVENTION

The present invention relates to the general field of devices capable of quantifying and locating a light signal.

More particularly, the invention pertains to the observation of a light signal captured by a plurality of photodiodes, this light being modulated at a predetermined frequency. The fact that several receivers are provided allows effective locating of the signal.

The invention specifically finds application in optical detectors such as those described in patent application FR 2 899 326 or FR 2 859 877.

A photodiode is an opto-electronic component which behaves as a current generator. The generated current is proportional to the light power illuminating the sensitive part of the photodiode.

The invention particularly relates to the measurement of the light power emitted by an emitter then reflected by an actuator.

The light emitter is typically a light-emitting diode emitting in the region of the infrared or visible light, so that the emitted light intensity is modulated at a given predetermined frequency.

The actuator is advantageously a user's finger in the applications specifically concerned by the invention.

The light power reflected by the actuator is then received by at least one photodiode, and measurement of the current derived from this photodiode gives information on the light power that it has received after processing by a logic system of microcontroller type.

To measure the current emitted by the photodiode, the simplest device is composed of a resistor placed in parallel with the photodiode and acting as a current-to-voltage converter, accompanied by an analogue/digital converter allowing acquisition of the voltage measured at the terminals of the resistor and, subsequently, the processing of this voltage by a microcontroller.

These types of devices are known to have a certain number of disadvantages.

When the voltage at the resistor terminals becomes higher than the threshold voltage of the diode, generally around 0.6 Volt, the photodiode behaves as a conventional diode and becomes conductive. Therefore, the voltage measured at the terminals of the resistor can never exceed 0.6 volt.

In addition, the photocurrent generated by a small-size photodiode is generally very low, of the order of magnitude of a few micro-amperes for a light intensity of one milliwatt per square centimetre. It is therefore necessary to use a resistor of higher resistance value, of the order of one mega Ohm. With said load, the reaction time of the system can become extremely long, in particular on account of the internal capacitance of the photodiode. The maximum frequency obtained is then very low.

It is therefore generally chosen to use a transimpedance amplifier assembly for example, using an operational amplifier whose output is connected to the analogue/digital converter. This assembly has the advantage of setting a near-zero voltage at the terminals of the photoreceptor and therefore overcomes voltage-related problems at the terminals of the photodiode. Having much lower input impedance, said assembly does not give rise to any problem concerning response time. If it is considered that the operational amplifier has a gain-bandwidth product of 10⁷ Hz, at a frequency of 10 kHz, the assembly has an input impedance of 100 ohms, for a load resistance of 100 kOhm.

Said assembly is therefore frequently used to amplify very weak currents. Nonetheless it suffers from the drawback of amplifying all currents, irrespective of their frequency.

Therefore, in optical applications, the effect of ambient light translates as the onset of a continuous component or a component of very low frequency whose amplitude exceeds the amplitude of the signal to be amplified by several orders of magnitude.

For example, a HSDL 5420 photodiode (Agilent) which supplies a mean photocurrent of 6 micro-amperes for an irradiance of 1 milliwatt per square centimetre, at a wavelength of 875 nanometres, is able to provide a photo-current of the order of magnitude of 0.1 milliampere for an irradiance of 140 milliwatt per square centimetre with a solar spectrum.

By comparison, the current derived from the light signal reflected by a user's finger can fall to a value of the order of 10 nano-amperes with a desired precision of 1 nano-ampere.

A factor of 10⁵ is therefore observed between the continuous or low frequency component and the signal to be measured.

In optical applications, it is to be noted that other perturbations of the optical signal are to be taken into account. Amongst these, filament lamps generate a luminous flux fluctuating at a frequency of 100 or 120 Hertz for a mains frequency of 50 or 60 Hertz. Conventional fluorescent lamps also generate luminous flux fluctuating at a frequency of 100 or 120 Hertz with abs(sinus) rectification unsmoothed for thermal inertia, which therefore has numerous harmonics. Fluorescent tubes having an electronic supply such as fluo-compact tubes or energy saving bulbs generate a luminous flux of higher frequency typically around 20 kHertz.

Other infrared communication mechanisms, remote controls, infrared communications between mobile equipment, etc. . . . , may also perturb the system.

One possibility for overcoming these perturbations is to modulate the signal emitted at a frequency chosen to be the least subject possible to external perturbations.

It is also possible to use a selective amplifier. In particular, there are numerous documents in the literature, in patents still in force or which have come into the public domain describing assemblies with which it is possible to achieve frequency selective amplification.

Among these selective amplifiers, mention may be made of the systems for suppressing continuous components such as the system described in patent U.S. Pat. No. 4,491,931 which uses a negative feedback loop on which the signal derived from the photodiode is amplified by a transimpedance amplifier and the low frequencies are then extracted from the amplified signal.

The low frequencies are then converted into current by a transducer amplifier before this current is removed from the input signal of the trans-impedance amplifier.

U.S. Pat. No. 4,227,155 and U.S. Pat. No. 4,275,457 describe said assemblies operating according to similar principles. These devices allow the useful signal to be insulated from parasitic signals. Nonetheless, they have the disadvantage of making it difficult to obtain high gain since they are limited by their vulnerability to ambient electromagnetic noise. Shielding is generally used but the cost thereof is prohibitive for mass implementation.

Patent application EP 1 881 599, for its part, describes an assembly allowing a transimpedance amplifier to be obtained which only amplifies one frequency band. Said assembly has the advantage of being simple and only requiring one operational amplifier and no external active component. Nonetheless, immunity to electromagnetic interference is no better than with systems suppressing continuous components.

It is therefore observed that known systems remain highly sensitive to electromagnetic perturbations for high gains, and do not allow sufficient performance levels for an optical sensor to be expected, in particular in terms of bandwidth or the filtering of external perturbations.

Finally, it is to be noted that known prior art devices are relatively expensive on account of the type of components used.

### OBJECTIVE AND SUMMARY OF THE INVENTION

The chief purpose of the present invention is therefore to overcome the drawbacks of prior art devices by proposing a device for quantifying and locating a light signal modulated at a predetermined frequency, characterized in that it comprises a digital control unit, a plurality of photodiodes arranged along two parallel, adjacent receiver lines having similar dimensional and electric characteristics extending from an amplifier device connected to a demodulator and forming a differential pair at the input of the amplifier device, the two terminals of each photodiode being respectively connected to one of the receiver lines, one of these terminals being connected to the receiver line via a switch of the type having two outputs and one input controlled by the digital control unit, this switch being capable of causing the photodiode to short-circuit, the controls of the switches being such that the photodiodes are successively connected to the two receiver lines, the control over the sequence of successive connections by the digital control unit allowing identification at each instant of the photodiode from which the differential signal is derived that is received at the input of the amplifier device whose output at each instant outputs a signal quantifying the light received by the photodiode(s) connected to the two receiver lines at this instant, the amplifier device further comprising a transimpedance amplifier stage whose inputs are each connected to one of the receiver lines of the differential pair and a frequency filtering stage capable of allowing the passing of signals at the predetermined frequency and of filtering at least the continuous or low frequency signals.

With said device the combining of two parallel receiver lines having similar characteristics carrying the plurality of photodiodes, together with the use of a transimpedance amplifier stage whose inputs are each connected to one of the receiver lines and supporting a filtering stage, ensures insensitivity to external electric and magnetic fields irrespective of the frequency thereof.

By using similar receiver lines, it is ensured that the electric and magnetic perturbations received by these receiver lines are identical and that the use of the differential pair at the input to the amplifier stage will allow the removal of electric and magnetic perturbations over all the frequencies in which they may occur. Since the two lines receive the same external electric perturbations and they both lead these to the input of the amplifier stage, these perturbations are mostly removed by the differential nature of the amplification.

The invention also combines the use of said lines connected to a differential amplifier, with direct connecting of the photodiodes each via their own switch. The use of an individual switch for each photodiode effectively ensures implantation where the lines of the differential pair remain the closest and most parallel possible.

The use of two-output, one-input analogue switches for each, photodiode allows either the short-circuiting of the diode, thereby insulating the current it produces from the remainder of the circuit, or the connecting of the two terminals of the photodiode onto the lines of the differential pair.

A direct connection, instead of a star-shaped or other connection, also avoids a variation in the length of the lines between the different receivers and emitters, which would give rise to different electric and magnetic perturbations in relation to the length or the characteristics of these lines.

Therefore according to the invention, the implantation characteristics of the photodiodes relative to the receiver lines are combined with the use of the receiver lines as a differential pair at the input to the amplifier stage.

The short-circuiting of the diodes by the switches allows the current produced by the diode to be insulated from the remainder of the circuit. When the diode is later connected to the receiver line via the switch, the photodiode will not have stored any charge via its internal capacitor. If the photodiode was only disconnected from the receiver line by being placed in an open circuit, its internal capacitor would charge during the entire time during which the photodiode is disconnected, and would directly discharge in the amplifier, thereby causing problematic transitory perturbations.

In addition, the use of at least one low-pass filter in combination with the other characteristics of the invention allows the elimination of parasitic light transiting at low frequency which cannot be removed by the differential nature of the pair of receiver lines.

The successive connections of the photodiodes on the receiver lines enable the digital control unit to know at each instant which diode is connected to the lines. The control unit is therefore able to locate the diode which receives the light when light is emitted by the emitter. Optionally, the switch controls can be such that it is several diodes, for example two diodes positioned symmetrically either side of an emitter, which are connected at the same time onto the receiver lines.

According to one preferred characteristic of the invention, each input of the transimpedance amplifier stage is earthed via a resistance, the ratio between the values of these resistances being adjusted and/or adjustable so as to ensure identical potential differences due to currents caused by the electric fields of external origin and of frequency close to the frequency pass-band of the filter on the two receiver lines at the input to the transimpedance amplifier stage.

This characteristic ensures that the electric perturbations are indeed similar on the two receiver lines at the input of the transimpedance amplifier stage when, for example, they receive different perturbing signals despite their parallelism. Said adjustment allows the effect of perturbations to be cancelled by the differential effect ensured by the amplifier. This adjustment does not change over time; it is generally set once and for all when the circuit is developed.

According to one preferred characteristic of the invention, since the transimpedance amplifier stage comprises an operational amplifier, the filter stage comprises a gyrator assembly that is load coupled with the operational amplifier and simulates inductance in the operating domain of the device.

The use of said gyrator assembly allows the fabrication of a device according to the invention which only uses usual, low-cost components allowing for cheap mass production.

In addition, said gyrator assembly load-coupled with the operational amplifier allows highly efficient filtering with high gain over a narrow frequency band.

In one particular embodiment, the gyrator assembly comprises an operational amplifier with direct negative counter-reaction by direct connection of the negative input of this operational amplifier to its output connected to the two terminals of the load impedance of the operational amplifier of the transimpedance amplifier stage, the negative input also being connected to the negative input of the operational amplifier of the transimpedance amplifier stage via a resistor, the positive input being connected to the negative input of the operational amplifier of the transimpedace amplification stage via a capacitor and to the output of the operational amplifier of the transimpedance amplifier stage via a resistor.

This structure of the gyrator assembly allows the simulation of an inductor.

In one preferred embodiment of the invention, in which the light signal to be quantified and located derives from light emitted by at least one emitter controlled at the predetermined frequency, the digital control unit controls the demodulator at the predetermined frequency and synchronously with the control signal of the emitter so that it accumulates charges during periods of illumination.

This characteristic prevents the digital signal obtained from being polluted by perturbations which could occur outside periods of illumination by the emitter(s). The demodulator may be an integrator with switched capacitor.

According to an additional characteristic of the invention, the lines are twisted in order to limit magnetic perturbations.

The invention also concerns a device for detecting the presence or the position of an object, comprising a device for quantifying and locating a light signal modulated at a predetermined frequency according to the invention, and emitters emitting light at a predetermined frequency controlled by the control unit of the device for quantifying and locating a light signal, these emitters being arranged alternately with the photodiodes of the device for quantifying and locating a light signal.

### BRIEF DESCRIPTION OF THE DRAWINGS

Other characteristics and advantages of the present invention will become apparent from the description give below with reference to the appended drawings which illustrate an example of embodiment thereof which is no way limiting. In the figures:

FIG. 1 schematically illustrates a device according to the invention;

FIGS. 2A and 2B show an example of implementation of the receiver lines used in a device of the invention, respectively as per a wiring diagram and as per path implementation in an integrated circuit;

FIG. 3 shows a conventional amplifier assembly with operational amplifier;

FIG. 4 illustrates an advantageous embodiment of a differential amplifier device such as used in the invention;

FIG. 5 schematically illustrates a gyrator assembly such as advantageously used in the invention;

FIG. 6 is an assembly similar to the gyrator assembly shown FIG. 4;

FIGS. 7A and 7B show the results obtained with one particular implementation of the invention;

FIG. 8 schematically illustrates an integrator with switched capacitor such as used in a device of the invention;

FIG. 9 shows a device for detecting the position of an object according to the invention;

FIG. 10 illustrates signals such as present at different points of the detection device in FIG. 9;

FIG. 11 gives an example of a flowchart for a detection device according to the invention.

### DETAILED DESCRIPTION OF ONE EMBODIMENT

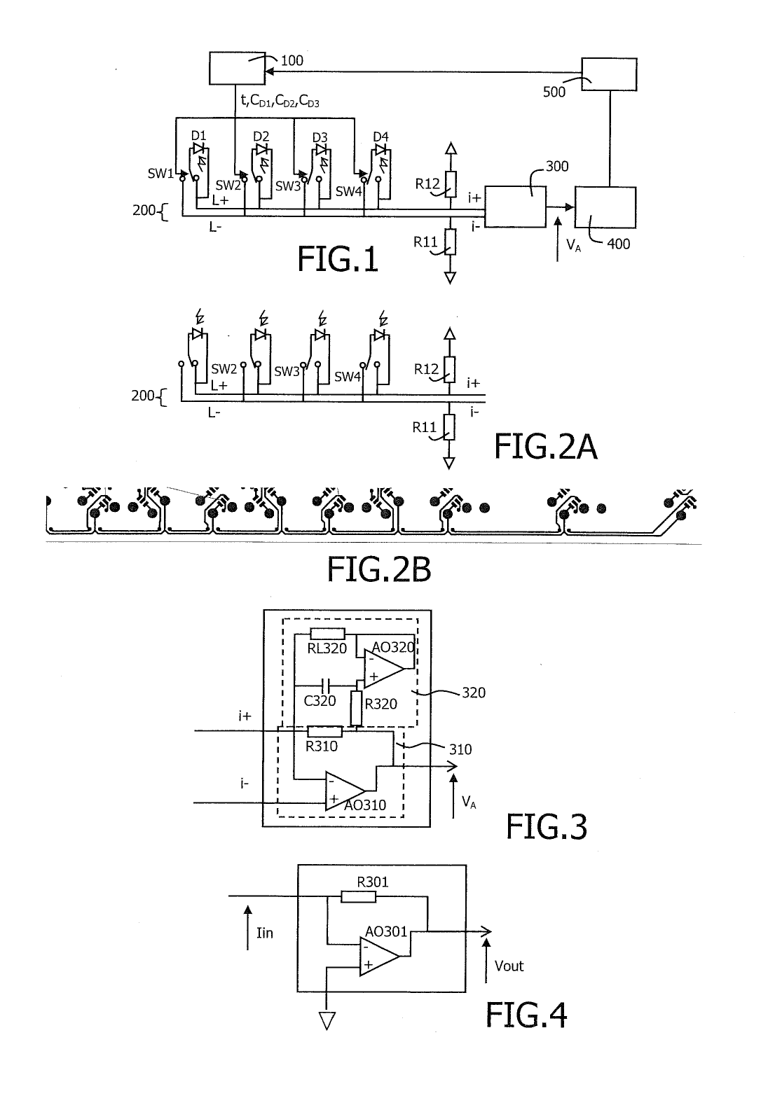

FIG. 1 schematically illustrates a device for quantifying and locating a light signal according to the invention. This device comprises a digital control unit 100, a plurality of photodiodes, here four photodiodes D1 to D4, arranged along a pair 200 of parallel receiver lines L− et L+ having similar dimensional and electric characteristics.

These receiver lines L−, L+ extend from an amplifier device 300 connected to an integrator demodulator 400 whose output signal is processed by an analogue/digital converter 500 which sends the data obtained to the control unit 100. The receiver lines L− and L+ form a differential pair at the input of the amplifier device 300.

According to the invention, as illustrated FIG. 2A, the two terminals of each photodiode D1 are each connected to one of the lines L−, L+. One of these terminals is connected via a switch SW1 to SW4 of the type with two outputs and one input. Each switch is controlled by the digital control unit 100 by signals denoted C_{D1} to C_{D4} synchronized with a clock t.

The two outputs of the switches SWi correspond to connection of the terminal of diode D1 to the receiver line, here L−, and to short-circuiting of the diode Di.

A practical example of implementation of the paths of the differential line and of the photodiodes associated with switches is illustrated FIG. 2B.

Controlling of the sequence of the successive connections of the photodiodes to the receiver line L-performed by the digital control unit 100 allows identification at each instant of the photodiode Di from which the differential signal derives that is received at the input of the amplifier device 300. This characteristic allows locating of the received light by identifying the photodiode on which the light of greatest power is received during one same illumination.

It is to be noted here that optionally several diodes may be connected to the two receiver lines at the same time. For example, two diodes that are symmetrical relative to one same emitter can be simultaneously connected to the two receiver lines.

The amplifier device 300, on its output, at each instant outputs a signal denoted V_{A} quantifying the light received by the photodiode(s) connected to the two receiver lines L− and L+ at this instant.

In one preferred embodiment of the invention, each receiver line L− and L+ is earthed by a resistor R11 and R12 respectively, placed at the input of the amplifier device 300.

These resistors R11 and R12 are advantageously adjusted at the time of forming the assembly according to the invention, or they can be adjusted by the user so that it is possible to adapt the device to various configurations. In the circuit illustrated FIG. 2B, the line connected to the inverting input of the transimpedance operational amplifier carries the components and the SPDT (Single Pole Double Throw) multiplexers. It is therefore slightly more sensitive to electric fields. The value of the resistor R12 is therefore adjusted iteratively by subjecting the circuit to an electric field of fixed frequency and by endevaouring to minimize the resulting signal at the output of the amplifier. For example 1 kΩ is obtained for resistor R11 connected to the non-inverting input, and 920Ω on the other resistor R12.

In particular, the device can be adapted to environments in which the two receiver lines L− and L+ receive different perturbing electric and/or magnetic signals.

The amplifier device 300 comprises a transimpedance amplifier stage whose inputs are each connected to one of the receiver lines L− and L+ of the differential pair 200, and a frequency filtering stage capable of allowing the passing of signals at the predetermined frequency and of filtering at least the continuous or low frequency signals.

An example of said amplifier device 300 is shown FIG. 3. It is formed of two parts 310 and 320, part 310 reproducing the characteristics of a simple inverting transimpedance assembly with an operational amplifier AO310, whereas part 320 allows the filtering of the differential signal at a predetermined frequency.

The output of the amplifier device 300 therefore chiefly only comprises the signal at the predetermined frequency contained in the differential signal.

The structure of the amplifier device 300 in FIG. 3 forms a preferred embodiment of the invention but does not exclude other possible embodiments fulfilling functions identical to those required for implementing the invention and defined in the claims.

FIG. 4 shows a stage 301 with an operational amplifier AO301 such as conventionally used in known electronic assemblies. This assembly 301 comprises an operational amplifier AO031 with feedback via a load resistor R301 on the negative input of the operational amplifier AO031.

With said assembly, an amplified output signal Vout is obtained corresponding to an amplified signal of the input signal Iin: Vout=R301 Iin.

The amplifier assembly such as illustrated FIG. 4 does not exhibit any performance of particular interest with regard to sensitivity to ambient electric and magnetic fields. This sensitivity is particularly an issue when the amplifier gains are high. These interfere with and deform the received signal.

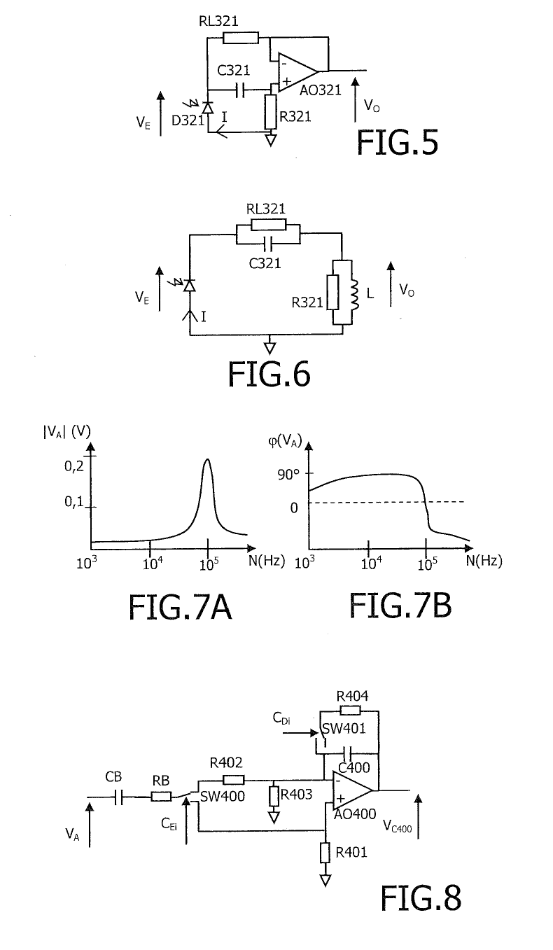

FIG. 5 shows a gyrator assembly such as implemented as filter stage 320 in the amplified device 300 of FIG. 3. In combination with the amplifier on which the differential pair is connected, said gyrator assembly simulates the presence of an inductor and leads to the desired frequency filtering. In FIG. 3 this gyrator assembly is load coupled with the operational amplifier AO310 and receives an input current.

In FIG. 5, this current is schematized by the presence of a photodiode D321 which injects a given current into the gyrator assembly 321. This current is denoted I in the remainder hereof. Therefore when said assembly is current-controlled, the voltage at the terminals of the D321 is:

$${V}_{E} = - I ( \frac{{R}_{32 \; 1} j L ω}{{R}_{321} + j L ω} + \frac{\frac{1}{j {C}_{321} ω} {R}_{L 321}}{\frac{1}{j {C}_{321} ω} + {R}_{L 321}} )$$

where L=R₃₂₁R_{L321}C₃₂₁.

This is equivalent to the circuit shown FIG. 6. The assembly therefore simulates an inductor.

The complex impedance of the assembly shown FIG. 6 is effectively identical to the one obtained with the calculation of VE.

Using the equations obtained with the gyrator assembly shown FIG. 5, when calculating the gain of the assembly in FIG. 3 by replacing the gyrator assembly by the equivalent impedance Z thereof, we obtain:

V_{A}=R₁₂i₊+(i₊−i₋)Z.

It is observed that it is not a true differential amplifier since the factor R₁₂i₊ perturbs measurement.

However, it is possible to consider that on the frequencies of interest to the invention, the impedance Z is much higher than the resistor R12 and it can therefore be considered that the amplifier thus obtained is a good approximation of a differential amplifier.

The gain of the amplifier which is dependent upon frequency, precisely allows some amplified frequency bands to be insulated from the others. We are therefore in the presence of a filter. Representing gain as a function of frequency allows visualization of the filtered frequencies.

This gives an amplifier having narrow frequency filtering which can be achieved with an operational amplifier having more limited performance levels than those needed for obtaining prior art assemblies.

A quantitative example of embodiment as per the assembly in FIG. 3 is given below with reference to FIGS. 7A and 7B which illustrate the results obtained with the chosen electronic components. The operational amplifier AO310 used is a double operational amplifier: TLC2272 by Texas Instruments. The operational amplifier AO320 is a STMicroelectronics TS461 operational amplifier.

The equivalent values L,R,C of the assembly in FIG. 6 are the following: RL321=1 k [symbol] ; C321=200 pF; R321=1 M [symbol] . The equivalent inductance is then L=RL321*R321*C321=0, 2H. Frequency filtering then has a pass-band centred on 10⁵ Hertz as can be seen FIG. 7A. FIG. 7B shows the phase behaviour of the filter. It shows the phase difference between the output signal and the input signal. Therefore, if Vin(t)=Vin0*e^{jωt} and Vout(t)=Vout0(ω)*e^{jωt+φ(ω)}, FIG. 7A represents Vout0(ω) and FIG. 7B represents φ(ω), input and output phase shifting.

In addition to frequency filtering, the use of two receiver lines mounted as a differential pair 200 at the input to the amplifier device 300 means that the greatest electromagnetic interference in the frequency band corresponding to the pass-band of the filter stage 320 formed here by means of the gyrator assembly, can be common mode interference i.e. it has the same effect on both lines of the pair 200. It is therefore eliminated by the differential amplifier.

On the contrary, the current derived from the photodiode Di connected to the two receiver lines is differential and the polarity of this current on one of the lines is the opposite polarity of this current on the second line. The current differential is therefore found at the output of the differential amplifier.

In addition, the independent and successive activation of the photodiodes allows the avoiding of changes in impedance on each photodiode since each short-circuited photodiode has practically zero load impedance and since the amplifier also has very low input impedance.

On the contrary, if we were to restrict ourselves to opening the circuit of each photodiode without prior short-circuiting thereof, the load of the photodiodes would change from zero impedance to infinite impedance and conversely when the circuit is closed.

These variations in impedance would cause charging and discharging of the internal capacitor of the photodiode in the amplifier, causing problematic transitory perturbations at the input to the differential amplifier device 300.

FIG. 8 shows an integrator demodulator assembly with a switched capacitor 400. This assembly 400 on its input receives the amplified voltage V_{A} output from the amplifier device 300.

This integrator assembly 400 comprises a first part allowing the further elimination of any residual low frequency parasitic signals. These are the elements CB and RB forming a filter RC.

The signal V_{A} is sent to that part of the assembly capable of performing integration thereof solely when one of the emitters Ei is switched on. For this purpose, a two-output, one-input switch SW400 switches from a position in which the voltage V_{A} is transmitted for integration to a position in which the voltage V_{A} is sent to a load resistor R401. The switch SW400 is therefore advantageously controlled with the control signal of the emitters C_{Ei}.

When the switch SW400 is in the position in which the voltage V_{A} is transmitted for integration, the voltage V_{A} is then transmitted via a resistor R402 to the negative input E₋ of an operational amplifier AO400. This input E₋ is earthed via a resistor R403. The other input E₊ of the operational amplifier AO400 is connected to the load resistor E401.

During integration of the signal, the voltage V_{A} is transmitted to a feedback capacitor C400 on the negative input of the operational amplifier AO400. This capacitor C400 then accumulates the current sent to the input of the integrator 400.

The accumulated signal V_{C400} is then able to be retrieved by the analogue/digital converter 500 at times synchronous with the control signals C_{Di}.

Therefore, at the end of each connection of one of the photodiodes Di, the signal V_{C400} is collected by the analogue/digital converter then the capacitor C400 is discharged via a switch SW401 which switches to a position in which the capacitor C400 is looped with the resistor R404 when the accumulated current is discharged. The switch SW401 is advantageously controlled by signals synchronous with the signals C_{Di}, controlling the successive connections of the diodes Di with the receiver lines, but slightly shifted to avoid transitory phenomena.

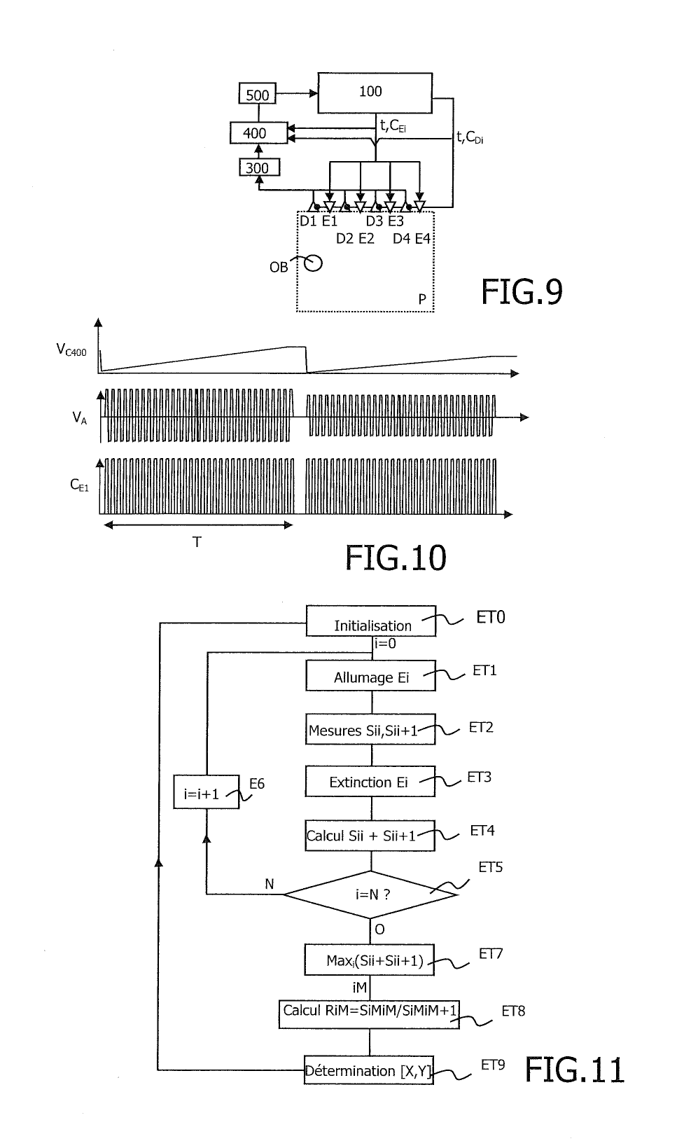

FIG. 9 schematically illustrates a device for detecting an object according to the invention. In addition to the device for quantifying and locating a light signal illustrated FIG. 1, this detection device comprises emitters E1 to E4 also controlled by the digital control unit 100 via signals C_{Ei} synchronized with a clock t. The control signals C_{E1} to C_{E4} allow successive activation of the emitters E1 to E4 one after another during times sufficient to allow each diode Di to be connected to the receiver lines for a sufficient period to allow integration of the signal received by each of these diodes under the same illumination. Optionally, only some diodes are able to receive light during illumination by a given emitter. In this case, only these diodes will be connected one after the other to the two receiver lines during illumination by the given emitter. This allows shortening of the response time of the detection device since only the pertinent diodes are interrogated.

Advantageously, the control signals C_{E1} to C_{E4} are such that the emitters E1 to E4 are switched off at the same time as the connection of one of the photodiodes to the differential pair is stopped.

This is illustrated FIG. 10 showing the control signal of one of the emitters C_{Ei} during the successive connection of two of the diodes C_{D1} and C_{D2} during a time T.

It can be seen that the emitter Ei is also stopped after the time T during which the diode D1 is connected to the two lines. It can also be seen that the output signal V_{A} of the amplifier device 300 is cancelled whenever the emitter E1 is stopped or the diode D1 is short-circuited.

Next, the emitter E1 starts to re-emit and a signal V_{A} of nonzero value but of smaller amplitude occurs at the output of the device 300. This signal V_{A} corresponds to the intensity received on the diode successively connected after diode D1, here diode D2.

It is observed that, for these successive connections of the diodes D1 and D2 onto the two lines, the signal V_{A} output from the amplifier device is of different amplitude. This results in a voltage V_{C400} which increases at a greater or lesser rate at the terminals of the capacitor C400.

It is therefore seen that the signal V_{C400} output from the integrator is stronger with the first diode D1 than with the second D2. After digital conversion, the received intensity is associated with an emitter Ei and a particular diode Dj and the signal thus obtained is denoted Sij. It is these signals associated with the emitters and with the receivers/photodiodes which will allow determination of the position of the object. In particular, in the present example, the reflection of the light emitted by the emitter E1 being greater on diode D1, it is possible to infer that the object is positioned closer to diode D1 than to diode D2.

FIG. 9 schematically illustrates a device for detecting the position of an object OB on a plane P extending opposite the emitters Ei and the photodiodes Di. The emitters Ei and the photodiodes Di here are aligned and arranged in emitter/photodiode alternation. The emitters Ei are controlled by the control signals C_{Ei} synchronized with a clock t. The photodiodes Di are controlled by the control signals C_{Di} also synchronized with the clock t.

An example of the overall operation of the detection device in FIG. 9 is described in the flowchart given FIG. 11. It is an application method in which a detection device of the invention is advantageously used.

In this flowchart, the method is initialized at a step ET0. An emitter Ei is then switched on at a step ET1. It is noted that, in this example, unlike the description given for FIG. 10, the emitter Ei is not switched off at the end of each measurement on a photodiode. Summing of perturbations can then be performed when the emitter is switched off. These perturbations are found in the final signal.

When the emitter Ei is switched on, successive measurements on each of the diodes Di,Di+1 adjacent the emitter Ei are taken at a step ET2. By limiting measurements to the photodiodes Di,Di+1 adjacent the emitter Ei, it is possible to increase the rapidity of the detection device.

At a step ET3, the emitter Ei is switched off. In the present example, the summing of the signals Sii+Sii+1 received by the two diodes Di,Di+1 adjacent the emitter Ei is performed at a step ET4. At step ET5 it is verified that all the N emitters have been successively switched on. If this is not the case, step ET6 increments i and the following emitter Ei+1 is switched on at a new step ET1. If this is the case the maximum sum Sii+Sii+1 is determined at a step ET7 before the ratio of the signals of the adjacent diodes is calculated at a step ET8. The maximum sum and the ratio SiMiM/SiMiM+1 between the signals received by adjacent diodes are used to determine the position (X,Y) of the object at a step ET9.

It is noted finally that various embodiments can be implemented along the principles of the invention.

1. Device for quantifying and locating a light signal modulated at a predetermined frequency, characterized in that it comprises a digital control unit (100), a plurality of photodiodes (D1,D2,D3,D4 . . . ) arranged along two parallel adjacent receiver lines (L+,L−) having similar dimensional and electric characteristics extending from an amplifier device (300) connected to a demodulator (400) and forming a differential pair at the input of the amplifier device (300), the two terminals of each photodiode (Di) being respectively connected to one of the receiver lines (L+,L−), one of these terminals being connected to the receiver line via a switch (SWi) of the type with two outputs and one input controlled by the digital control unit (100), this switch (SWi) being capable of causing short-circuiting of the photodiode (Di), the controls of the switches (SW1-SW4) being such that the photodiodes (D1-D4) are successively connected to the two receiver lines (L+,L−), the control over the sequence of successive connections by the digital control unit (100) allowing the identification at each instant of the photodiode (Di) from which the differential signal derives that is received at the input of the amplifier device (300) whose output at each instant outputs a signal (V_{A}) quantifying the light received by the photodiode(s) (Di) connected to the two receiver lines (L+, L−) at this instant, the amplifier device (100) further comprising a transimpedance amplifier stage (310), whose inputs are each connected to one of the receiver lines (L+,L−) of the differential pair, and a frequency filtering stage (320) capable of allowing the passing of signals at the predetermined frequency and of filtering at least the continuous or low frequency signals.

2. The device according to claim 1, characterized in that each input of the transimpedance amplifier stage (310) is earthed via a resistor (R11, R12), the ratio between the values of these resistors being adjusted and/or adjustable to ensure identical differences in potential due to the currents caused by electric fields of external origin and of frequency close to the frequency pass-band of the filter on the two receiver lines (L+,L−) at the input of the transimpedance amplifier stage (310).

3. The device according to claim 1, characterized in that since the transimpedance amplifier stage (310) comprises an operational amplifier (AO310), the filtering stage (320) comprises a gyrator assembly load coupled with the operational amplifier (AO310) and simulating inductance in the operating region of the device.

4. The device according to claim 3, characterized in that the gyrator assembly comprises an operational amplifier (AO320) with direct negative counter-reaction by direct connection of the negative input of this operational amplifier (AO320) to its output connected to the two terminals of a load impedance (R310) of the operational amplifier (AO320) of the transimpedance amplifier stage (320), the negative input of the latter also being connected to the negative input of the operational amplifier (AO310) of the transimpedance amplifier stage (310) via a resistor (RL320), the positive input being connected to the negative input of the operational amplifier (AO310) of the transimpedance amplifier stage (310) via a capacitor (C320) and to the output of the operational amplifier (AO310) of the transimpedance amplifier stage (310) via a resistor (R320).

5. The device according to claim 1 characterized in that the light signal to be quantified and located being derived from light emitted by at least one emitter (Ei) controlled at the predetermined frequency, the digital control unit (100) controls the demodulator (400) at the predetermined frequency and synchronously with the control signal of the emitter (Ei) so that it accumulates the charges during the periods of illumination.

6. The device according to claim 1, characterized in that the lines (L+, L−) are twisted to limit magnetic perturbations.

7. A device for detecting the presence or position of an object (OB), comprising a device for quantifying and locating a light signal modulated at a predetermined frequency according to claim 1 and emitters (E1,E2,E3,E4) emitting light at a predetermined frequency controlled by the control unit (100) of the device for quantifying and locating a light signal, these emitters (E1,E2,E3,E4) being alternately arranged with the photodiodes (D1,D2,D3,D4) of the device for quantifying and locating a light signal.
